(19) United States
(12) Patent Application Publication
(10) Pub. No.: US 2024/0160727 A1
(43) Pub. Date: May 16, 2024

(54) Detecting anomalous Application Programming Interface (API) behaviors

(71) Applicant: Akamai Technologies, Inc., Cambridge, MA (US)

(72) Inventors: Charles E. Gero, Quincy, MA (US); Vishal A. Patel, Billerica, MA (US)

(73) Assignee: Akamai Technologies, Inc., Cambridge, MA (US)

(21) Appl. No.: 17/982,562

(22) Filed: Nov. 8, 2022

(51) Int. Cl. G06F 21/55; G06F 21/57

(52) U.S. Cl. CPC G06F 21/554; G06F 21/577; G06F 2221/033

(57) ABSTRACT

A technique to detect and mitigate anomalous Application Programming Interface (API) behavior associated with an application having a set of APIs is described. Across one or more sessions during a time period, and in response to receiving a set of one or more transactions directed to the application, a behavioral graph is generated. The graph comprises a set of vertices, an associated set of edges, and a set of weights representing frequency of observation of one or more behaviors, wherein a behavior is denoted by an edge between a pair of connected vertices, wherein the edge depicts at least one interdependent relationship between first and second APIs of the set of APIs. One or more low weight edges are filtered from the behavioral graph to generate a decision graph. The decision graph is then used to detect that one or more new transactions represent anomalous behavior. In response to detecting that the given new transaction represents the anomalous behavior, an action is taken to protect the application.

### BACKGROUND

### Technical Field

This application relates generally to protecting online digital properties that incorporate Application Programming Interfaces (APIs).

### BRIEF DESCRIPTION OF THE RELATED ART

APIs have become a standard way of building modern applications and improving digital experiences. Applications often comprise multiple APIs with different datasets and updates. Typically, API attacks are low and slow, as attackers spend time to map the API structure, understand the logic, and look for vulnerabilities to exploit. Traditional tools miss this kind of subtle attacker activity. The problem is exacerbated by the growing number of APIs and their high rate of change, which lead to extremely large, ever changing attack surfaces. Further, in modern API-based web architectures, API client code (and its complex business logic) has been moved outside of the data center and onto the user's device, such as a mobile phone or tablet, while at the same time the data center typically relies on public APIs that can be accessed directly from the Internet. As a result, complex interdependent relationships between and among API calls are fully exposed to a potential attacker, and many API-based attacks pose significant detection and mitigation challenges.

### BRIEF SUMMARY

This disclosure describes a technique to detect interdependent relationships between and among API calls to an API endpoint and, in particular, to distinguish between high frequency API behaviors, which are assumed to be normal and expected, and low frequency behaviors, which are considered to be anomalous. The approach herein provides for an efficacious heuristic to detect certain classes of anomalous API behavior directed to a protected API endpoint. As a practical application, the approach herein is integrated with an overlay network security solution to detect and mitigate an API-based attack against the API endpoint.

According to one embodiment, a method to detect and mitigate anomalous Application Programming Interface (API) behavior associated with an application having a set of APIs is described. Across one or more sessions over some time period, and in response to receiving a set of one or more transactions directed to the application, a behavioral graph is generated. The graph comprises a set of vertices, an associated set of edges, and a set of weights representing frequency of observation of a related behavior denoted by the edge between connected vertices. The behavioral graph depicts at least one interdependent relationship between first and second APIs of the set of APIs, typically where the first API is a transaction, and the second API is a subsequent transaction associated with the transaction. After completing the generation of the behavioral graph for one time period, the resultant behavioral graph is combined with behavioral graph(s) that were generated in one or more prior time period(s). When the combination occurs, weights in one or more of the graphs may be modified, e.g., through use of an exponential moving average. Preferably, the combined graph that results is then passed through a high pass filter that removes low weight edges and any orphaned vertices to produce a decision graph. Generation of the decision graph may also involve additional operations, such as removing extraneous information, and by applying a configurable override graph. The decision graph is then used to detect whether new transactions represent anomalous behavior. In particular, and in response to detecting that some new transaction represents the anomalous behavior, a remedial action is then taken to protect the application.

The foregoing has outlined some of the more pertinent features of the subject matter. These features should be construed to be merely illustrative. Many other beneficial results can be attained by applying the disclosed subject matter in a different manner or by modifying the subject matter as will be described.

### BRIEF DESCRIPTION OF THE DRAWINGS

For a more complete understanding of the subject matter and the advantages thereof, reference is now made to the following descriptions taken in conjunction with the accompanying drawings, in which:

FIG. 1 depicts an overlay network operating environment in which the techniques of this disclosed may be implemented;

FIG. 2 depicts an edge server machine operating in the environment depicted in FIG. 1;

FIG. 3 depicts an active TLS session among a requesting end user client, an edge server, and an application executing on an origin server, and wherein the application has one or more APIs;

FIG. 4 depicts how modern web architectures that support APIs are subject to API-based attack;

FIG. 5 depicts a high level visual representation of an API detection mechanism according to this disclosure that comprises a set of processing stages;

FIG. 6 depicts a representative behavioral graph generated by the API detection mechanism with respect several API endpoints associated with a network-accessible banking application;

FIG. 7 depicts representative vertex data for the API endpoints in the behavioral graph shown in FIG. 6.

FIG. 8 depicts a representative decision graph generated by the API detection mechanism and corresponding to the behavioral graph in FIG. 6;

FIG. 9 depicts a representative overrides graph that may be applied by the API detection mechanism;

FIG. 10 depicts a modification of the decision graph shown in FIG. 7 after application of the overrides graph shown in FIG. 8;

FIG. 11 depicts a variant embodiment wherein an acyclic behavioral graph is restructured as a directional cyclic graph (DCG); and

FIGS. 12A-C depict an example of how a behavioral graph is high pass-filtered to produce a decision graph as described herein.

### DETAILED DESCRIPTION

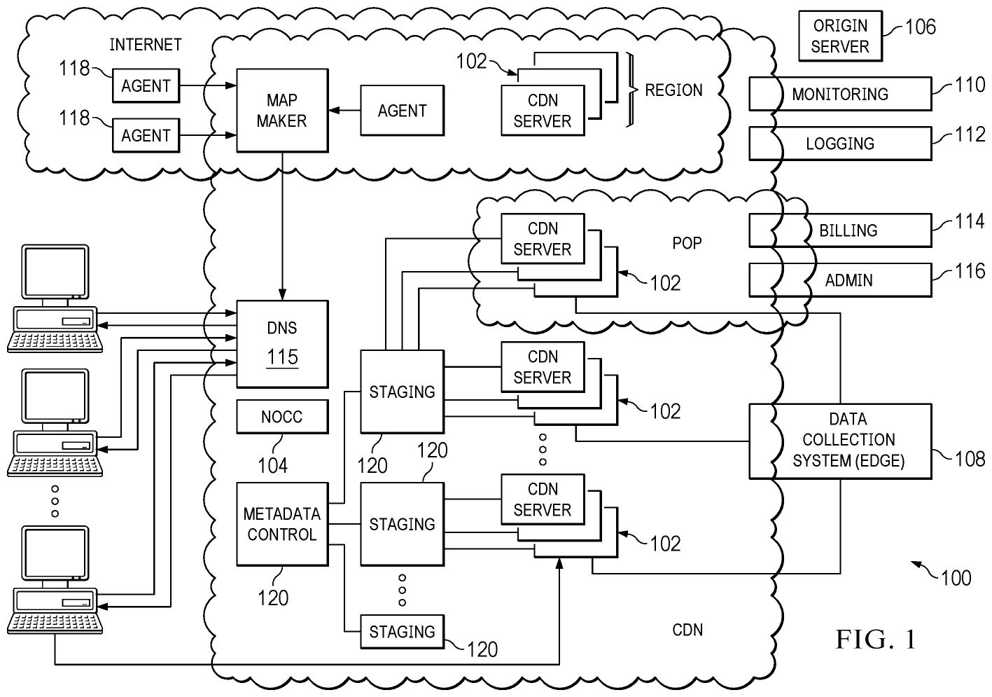

In a known system, such as shown in FIG. 1, a distributed computer system 100 is configured as a content delivery network (CDN) and is assumed to have a set of machines 102a-n distributed around the Internet. Typically, most of the machines are servers located near the edge of the Internet, i.e., at or adjacent end user access networks. A network operations command center (NOCC) 104 manages operations of the various machines in the system. Third party sites, such as web site 106, offload delivery of content (e.g., HTML, embedded page objects, streaming media, software downloads, and the like) to the distributed computer system 100 and, in particular, to “edge” servers. Typically, content providers offload their content delivery by aliasing (e.g., by a DNS CNAME) given content provider domains or sub-domains to domains that are managed by the service provider's authoritative domain name service. End users that desire the content are directed to the distributed computer system to obtain that content more reliably and efficiently. Although not shown in detail, the distributed computer system may also include other infrastructure, such as a distributed data collection system 108 that collects usage and other data from the edge servers, aggregates that data across a region or set of regions, and passes that data to other back-end systems 110, 112, 114 and 116 to facilitate monitoring, logging, alerts, billing, management and other operational and administrative functions. Distributed network agents 118 monitor the network as well as the server loads and provide network, traffic and load data to a DNS query handling mechanism 115, which is authoritative for content domains being managed by the CDN. A distributed data transport mechanism 120 may be used to distribute control information (e.g., metadata to manage content, to facilitate load balancing, and the like) to the edge servers.

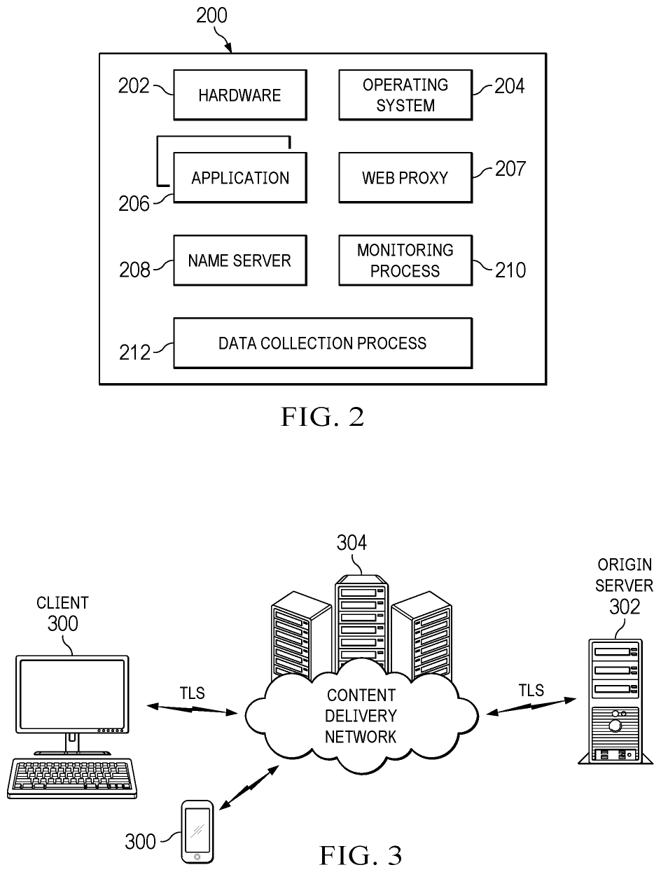

As illustrated in FIG. 2, a given machine 200 comprises commodity hardware (e.g., an Intel® processor) 202 running an operating system kernel (such as Linux or variant) 204 that supports one or more applications 206a-n. To facilitate content delivery services, for example, given machines typically run a set of applications, such as an HTTP proxy 207 (sometimes referred to as a global host process), a name server 208, a local monitoring process 210, a distributed data collection process 212, and the like. The HTTP proxy 207 or “edge server”) serves web objects, streaming media, software downloads and the like. A CDN edge server is configured to provide one or more extended content delivery features, preferably on a domain-specific, customer-specific basis, preferably using configuration files that are distributed to the edge servers using a configuration system. For example, a given configuration file preferably is XML-based and includes a set of content handling rules and directives that facilitate one or more advanced content handling features. The configuration file may be delivered to the CDN edge server via the data transport mechanism. U.S. Pat. No. 7,111,057 illustrates a useful infrastructure for delivering and managing edge server content control information, and this and other edge server control information can be provisioned by the CDN service provider itself, or (via an extranet or the like) the content provider customer who operates the origin server.

The CDN may provide secure content delivery among a client browser, edge server and customer origin server. Secure content delivery enforces SSL/TLS-based links between the client and the edge server process, on the one hand, and between the edge server process and an origin server process, on the other hand. This enables an SSL/TLS-protected web page and/or components thereof to be delivered via the edge server.

As an overlay, the CDN resources may be used to facilitate wide area network (WAN) acceleration services between enterprise data centers (which may be privately-managed) and third party software-as-a-service (SaaS) providers.

In a typical operation, a content provider identifies a content provider domain or sub-domain that it desires to have served by the CDN. The CDN service provider associates (e.g., via a canonical name, or CNAME) the content provider domain with an edge network (CDN) hostname, and the CDN provider then provides that edge network hostname to the content provider. When a DNS query to the content provider domain or sub-domain is received at the content provider's domain name servers, those servers respond by returning the edge network hostname. The edge network hostname points to the CDN, and that edge network hostname is then resolved through the CDN name service. To that end, the CDN name service returns one or more IP addresses. The requesting client browser then makes a content request (e.g., via HTTP or HTTPS) to an edge server associated with the IP address. The request includes a host header that includes the original content provider domain or sub-domain. Upon receipt of the request with the host header, the edge server checks its configuration file to determine whether the content domain or sub-domain requested is actually being handled by the CDN. If so, the edge server applies its content handling rules and directives for that domain or sub-domain as specified in the configuration. These content handling rules and directives may be located within an XML-based “metadata” configuration file.

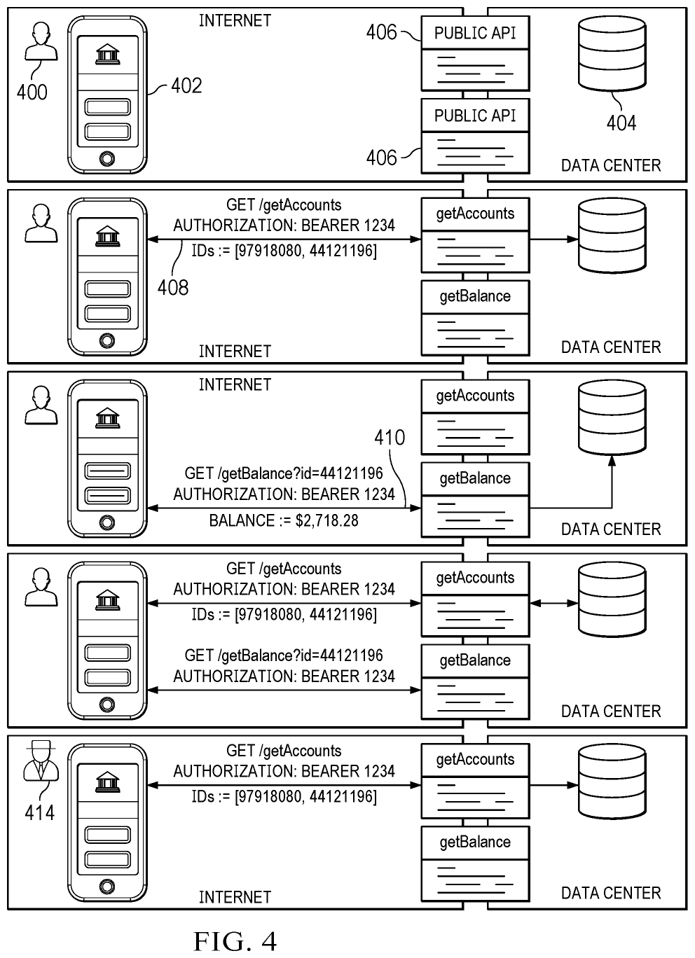

As illustrated in FIG. 3, in the typical interaction scenario, an end user client browser or mobile app 300 is associated with an application executing on a customer origin server (or “origin”) 302 via the intermediary of an overlay network edge machine server instance 304 (the “edge server”). The terms “origin” or “edge” are not intended to be limiting. The application, such as a web-based banking application, has one or more APIs. FIG. 4 depicts how these APIs may be monitored and exploited. In particular, assume that banking customer (end user) 400 has a mobile device that executes a banking app 402. The banking app 402 interoperates with a back-end application 404 that executes in a data center. The back-end application 404 corresponds to the origin in FIG. 3, and it includes a set of APIs 406. When this type of web application is supported in a CDN such as depicted in FIG. 1, interactions between the client and server sides flow through the CDN edge servers (as also depicted in FIG. 3). For simplicity, the edge servers are omitted in FIG. 4. At step (1), assume that the end user, via the mobile app, makes a request to the server infrastructure for information about his bank accounts. The request is directed to a getAccounts API 406, and it includes an Authorization corresponding to the user's mobile device. The API request 408 results in the getAccount API returning a response that includes the user's accounts. At step (2), the user issues a request 410 to another API, the getBalance API, to obtain his account balance for the identified account, once again using the bearer Authorization. The getBalance API returns the requested balance. Because the APIs are public-facing and, as depicted, potentially expose the same or related data about the end user's accounts, an attacker 414 that is able to monitor these flows learns about the interdependent relationships among these API calls and uses that information to create an appropriate attack vector.

The techniques of this disclosure provide for a mechanism to address the above-described type of vulnerability where an attacker attempt to exploit the interdependent relationships among API calls to a protected application.

In one embodiment, the mechanism executes in association with an overlay network that comprises a set of edge server regions such as depicted in FIG. 1. This implementation is not intended to be limiting, as further explained below. Before describing the mechanism, and by way of additional background, the following terms as used herein have the following definitions.

An “API consumer” is a user, machine, or application that interacts with an API.

An “API definition file” is a file in an OpenAPI (Swagger) or RAML format that includes information about an API configuration.

An “API endpoint” is an application that hosts one or more API resources with a common base path. The representation of an API endpoint is a unique URL that includes a hostname and a base path.

An “API gateway” is a single-point software layer between one to many API services and their consumer applications.

An “API key” is a unique identifier that enables edge servers to authenticate, track, and manage API consumers.

An “API resource” is a service within an API endpoint represented by a URI. An API consumer interacts with an API resource via its allowed methods.

A “behavior” is an element in a rule that specifies a feature to apply to requests. A rule can have many behaviors or only one.

A “digital property” is an identifier that indicates which property file and application to use when processing incoming HTTP requests. Often, the digital property is a full, end-user-facing hostname or fully qualified domain name of an application.

An “edge hostname” is a customer-specific subdomain on a domain that maps incoming requests to edge servers. Typically, customers specify edge hostnames in Canonical Name (CNAME) records.

An “edge server” is an overlay network-provided server that receives end-user requests and provides an integrated suite of services for content and application delivery, content targeting, edge processing, and business intelligence. FIG. 2 depicts a representative edge server. An edge server region typically comprises a set of co-located edge servers. There may be many edge servers regions that comprise the overlay network, and in a large scale overlay network edge server regions typically are located across many geographic and network locations, possibly around the world.

An “origin server” is a server where content is published and kept by a content provider, e.g., an overlay network customer. An overlay network service provider retrieves content from the origin server and serves it from its edge servers.

An “origin server hostname” is a hostname mapping to the customer's origin server where edge servers retrieve customer content.

A “manager application” is a secure, network-accessible application that a customer uses to provision, configure, test, and activate digital properties.

A “rule” is an instruction that controls how the overlay network provider (at its edge servers) applies features to requests. Rules typically consist of two parts: match criteria and behaviors. If a request fulfills the requirements given in a rule's match criteria, the edge server applies the features configured in that rule's behaviors. A configuration typically has multiple rules.

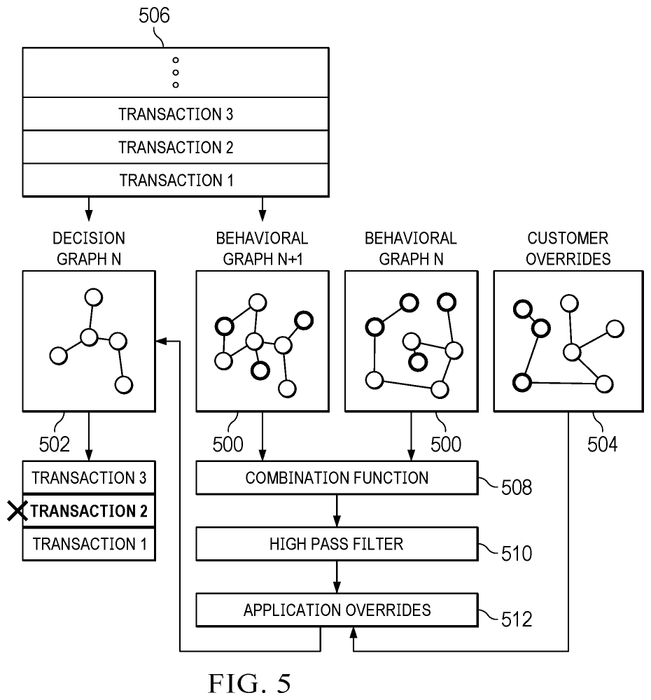

With the above as background, reference is now made to FIG. 5, which provides a high level visualization of the API detection mechanism of this disclosure. As will be described, the approach herein implements a heuristic that attempts to detect API attacks by distinguishing between high frequency behaviors, which are assumed to be normal and expected, and low frequency behaviors, which are considered to be anomalous. The mechanism uses graph-based techniques for this purpose. In particular, API behaviors are captured in a graph that comprises a set of vertices (nodes), edges, and (typically) weights reflecting frequency of observation. Preferably, a given graph comprises a set of vertices of various types, together with its associated edges of various types. As depicted in FIG. 5, there are several different types of graphs captured or used, namely, a behavioral graph 500, a decision graph 502, and optionally an override graph 504. In FIG. 5, two behavioral graphs are shown, namely, behavioral graph N that represents an existing behavioral graph for an API (or a version of the API, or some portion of the API), as well as behavioral graph N+1 that represents a current version of the API behavioral graph N. The current version of the behavioral graph (namely, the N+1 version) is based on a set of one or more transactions 506 that are depicted as being captured, e.g., at a given edge server or edge server region in the overlay network. The decision graph 502 represents a behavioral graph that has been instantiated for use is detecting whether the transactions 506 represent an anomalous API behavior of interest that has been characterized by the behavior graph. In a representative implementation, the decision graph 502 is instantiated at an edge server (or edge server region) and used for detecting anomalous API behavior for a given time period, e.g., until it is replaced with a new decision graph. Once an anomaly is detected, the edge server then takes a given mitigation/remediation action as necessary. Typically, the given action is defined by an edge server enforcement policy (namely, one or more rules) and may include, without limitation, rejection of a particular transaction (such as shown in FIG. 5), issuing a notification, flagging a transaction for further analysis, sand-boxing or slowing down further requests associated with the API, and the like.

Preferably, the process of building the behavioral graph(s) and then instantiating them (as decision graphs) in the edge server (or edge server region) operates continuously, thereby observing transactions over time. Generalizing, the approach herein involves iterations through several phases, namely, (1) behavioral observation, (2) decision graph creation, and (3) detection and mitigation.

Behavioral observation refers to dynamically building a behavioral graph 500 that structurally captures usage patterns, good and/or bad, of a given API, through observation of transactions 506 over some time interval. As transactions occur over a distributed overlay platform such as depicted in FIG. 1, this operation preferably leverages some amount of central processing of transaction data for a given API. In the context of FIG. 5, behavioral graph N may depict a graph generated at a particular edge server (or edge server region) of the overlay network, while behavioral graph N+1 may then depict a graph generated at some other edge server (or edge server region) of the overlay network. In a typical embodiment, two or more edge servers are each monitoring the transactions flowing through locally (at their respective edge server regions) and generating respective behavioral graphs (N+1 in this example). These behavioral graphs are then shared to a central processing location at which the behavioral graph N for the API has been generated previously. There may be one or more central processing locations, and a particular API may have its own ingest and processing location.

Decision graph creation is generally as follows. Once a behavioral graph 500 (typically one or more of them, as previously described) has been created, it is processed and distilled into a decision graph 502 that preferably contains only high frequency patterns. Generalizing, the decision graph 502 is a distillation of a behavioral graph 500 that is designed to provide the bare minimum amount of information required to determine if a transaction is anomalous or not. Typically, the decision graph 502 has the same structure as a behavioral graph 500, with the exception that both low frequency behaviors and edge weights are removed. To achieve this, several processing steps are taken as shown in FIG. 5, namely, graph combination 508, high pass filtering 510, and application of overrides 512. Graph combination 508, as previously described, involves a newly-created behavioral graph (graph N+1) combined with a prior behavioral graph (graph N) to allow for smoothing of newly-observed behavior and the deprecation of older observed behaviors. As also described, such combinations may also be used to take into consideration API transactions identified from disparate sources (typically, but without limitation, first and second edge servers operating in different edge server regions). High pass filtering 510 takes the output of the graph combination operation 508 and passes it through a filter that eliminates both low frequency behaviors, orphaned vertices, and extraneous information. A low frequency behavior is a behavior that has a low weight value (e.g., typically one or more orders of magnitude) as compared to the other weights in the behavioral graph. Finally, one or more overrides 512 are then applied and, in particular, by taking the output of the filtering operation 510 and filtering it further though a set of one or more overrides to prune the decision graph 502 further, while additionally potentially reintroducing valid but low frequency behaviors, e.g., that the system has recognized or that a customer has manually approved. Overrides typically are defined by or for a given overlay network customer, and thus graph 504 is sometimes referred to herein as a customer override graph.

Regarding overrides, preferably overlay network customers have an option of overriding the decision graph's determination for transactions. This is accomplished through the customer configured override graph 504 that acts as a mask and is overlaid on the decision graph. Typically, and as will be described in more detail below, this graph takes the same form as the decision graph with the exception that all vertices and edges contain an additional mode attribute that determines if the element is additive to the decision graph or subtractive.

Referring back to FIG. 5, detection and mitigation then proceeds as follows. In particular, once a decision graph 500 has been generated, it is utilized to perform detection of anomalous transactions, e.g., at the overlay network edge, at the central ingest point, or at some other location, such as an API gateway. If detection occurs at the edge, inline mitigations such as blocking are performed, preferably in real-time. As described above, and during the interval in which a given decision graph 500 is being utilized at an enforcement point, a brand new behavioral graph is simultaneously being created through the process outlined above. And, as noted such a progression preferably continues forward continuously. In the usual case, and generalizing, a behavioral graph is generated across one or more sessions over a given time period. Upon completion of the generation of the behavioral graph for the time period, the resulting graph is then combined with one or more such graphs generated from one or more prior time periods. Typically, and when behavioral graphs are combined, weights are also modified.

In particular, the following provides additional details regarding a representative graph combination function, such as function 508 in FIG. 5. As noted, the purpose of the combination function is to manage the transition from one behavioral graph (graph N) to the next (graph N+1). In one non-limiting implementation, the graphs are combined utilizing an exponential moving average across the weights of like edges. The following describes this process. In particular, define a behavioral graph G to be an ordered triplet consisting of the set of vertices V, the set of edges E, and the set of weights W, namely G=(V, E, W). Edges are themselves ordered triplets, with the first element representing a starting vertex, the second element representing a terminating vertex, and the third element assigning an edge type (as described further below) from a set T:

E={(v₀∈V,v₁∈V,t∈T), . . . }

Weights are ordered pairs, with a first element being an edge, and a second element being a weight chosen from the set of natural numbers inclusive of 0:

W={(e∈E,w∈ [symbol] ₀), . . . }

Now, define a function [symbol] that returns the weight of an edge within a graph, or 0 if missing:

$$𝓌 ( e , G ) = \{ \begin{matrix}weight of the edge e within the weight set W ; if e ∈ E \\ 0 ; otherwise\end{matrix}$$

With the above, the prior and new graphs are defined as follows:

Gₚᵣᵢₒᵣ=(Vₚᵣᵢₒᵣ,Eₚᵣᵢₒᵣ,Wₚᵣᵢₒᵣ)

G_{new}=(V_{new},E_{new},W_{new})

The set of vertices in the combined graph is the union of the prior vertices and new vertices:

V_{combined}=Vₚᵣᵢₒᵣ∩V_{new}

The set of edges in the combined graph is the union of the prior edges and new edges:

E_{combined}=Eₚᵣᵢₒᵣ∩E_{new}

Finally, the set of weights in the combined graph is the exponential moving average (EMA) as described earlier, with α being the dominant EMA term:

W_{combined}={(e,w)∈(E_{combined}× [symbol] ₀)|w= [symbol] (e,G_{new})*α+ [symbol] (e,Gₚᵣᵢₒᵣ)*(1−α)┘}

Thus, yielding the new combined graph:

G_{combined}=(V_{combined},E_{combined},W_{combined})

This combined graph is treated as Gₚᵣᵢₒᵣ in the next interval.

Note that a behavioral graph can be locked by setting α to 0.0, and the prior behavioral graph can be made irrelevant by setting α to 1.0.

As mentioned, the EMA combination function is not intended to be limiting, as other graph combination functions may be implemented as well.

As also described above, the role of the high pass filtering 510 (the high pass filter) is to generate the decision graph from a behavioral graph. Preferably, the high pass filter performs the following steps. First, all low frequency edges are removed. Low frequency edges represent anomalous behavior. The criteria for whether an edge is a low frequency edge may vary. Examples include, without limitation, not meeting a minimum absolute threshold, falling below a percentage of maximum weight observed, and the like. After removing low frequency edges all disconnected graphs not containing the session vertex are discarded. Thereafter, the weights are removed from all edges to complete the filtering process.

### Behavioral Graph Generation

The following are a list of the high level data structures and components that are used to compose the heuristic in a representative but non-limiting implementation. There is no requirement that these particular data structures be used, as variants or alterations that produce the same set of behaviors may be used.

In a preferred embodiment, the behavioral graph is a weighted directed acyclic graph, constructed through observation of transactions, which describes the behavior of a specific version of an API (or API version, API method, etc.). The vertices (nodes) of this graph represent various components of the requests and responses that have been discovered during some time interval T. Additionally, preferably vertices have a type and associated data. The edges represent relationships between two vertices and preferably carry a weight that reflects a heat of the relationship, or more specifically, the count (preferably an absolute one) of the relationship between the connected vertices that was observed during T. Edges in the graph may be calls, signatures of calls, data passed into calls, and data returned. Like vertices, edges have types as well. To understand this graph better, the following lists out the various vertex and edge types before providing an example. The following list of vertices and edges is only representative, and there may be changes, additions, and removals.

Representative vertex types include, without limitation, session, endpoint, request_signature, response_signature, and value. The session is the starting vertex in the graph and is the root of a session. Typically, a session corresponds to a set of interactions between an API consumer and the API endpoint. The session vertex typically contains no additional data. The endpoint type represents an API endpoint and contains an associated scheme and hostname used to reach it. An example endpoint type is endpoint.url:=${URL}.

The request_signature type represents an API endpoint request signature. The signature contains information about how request data was sent, a canonicalized list of parameter names, their types, and depending on the given type of a parameter, its observed limits, e.g.:
request_signature.method:={GET|POST}
request_signature.encoding:={NONE|URL|JSON| . . . }
request_signature.param[n].name:=${NAME}
request_signature.param[n].type:={INTEGER|STRING|ARRAY| . . . }
iff request_signature.param[n].type is NUMERIC
   request_signature.param[n].limits.min:=${MIN_OBSERVED}
   request_signature.param[n].limits.max:=${MAX_OBSERVED}.

The response_signature type represents an API endpoint response signature. This type contains all of the information from request_signature, with the exception of the omission of method and the addition of status_code:
response_signature:=${STATUS_CODE}.

The value type represents a value that was either passed into or returned from an API endpoint. Actual values from transactions are not stored within this vertex. It is simply utilized as a vertex that links shared values between calls when they occur.

Representative edge types include, without limitation, called, with, returned, any_value, and prior_value. The called edge type indicates some session called a specific endpoint. Thus, this type of edge is directed from vertex session to endpoint. The with edge type indicates an endpoint was called with a specific signature. Thus, this type of edge is directed from vertex endpoint to request_signature. The returned edge type indicates a called endpoint returned with a given response_signature. Thus, the type is directed from request_signature to response_signature. The any_value edge type indicates at the time a request_signature or response_signature was observed from some session, a given parameter utilized a value not seen earlier in the session. This type of edge therefore is directed from a specific parameter index within a request_signature or response_signature to a value. The prior_value edge type indicates at the time a request_signature or response_signature was seen for some session, a given parameter utilized a value that was seen earlier in the session. Thus, this type of edge is directed from a specific parameter index within a request_signature or response_signature to a value.

### An Example Use Case—Banking Application

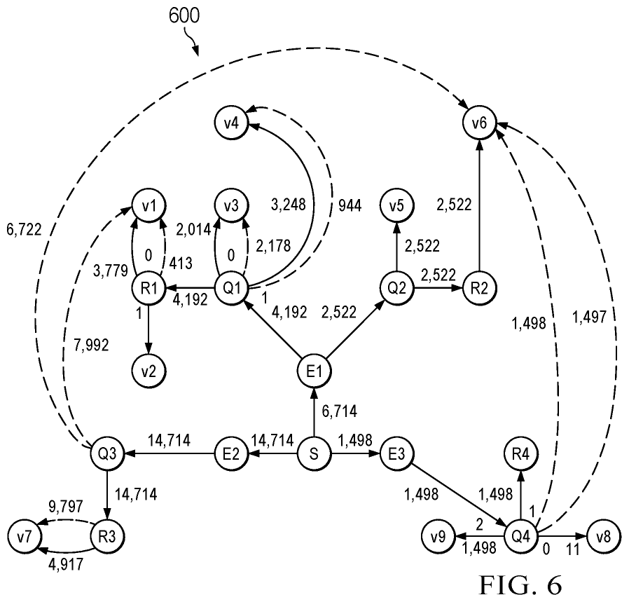

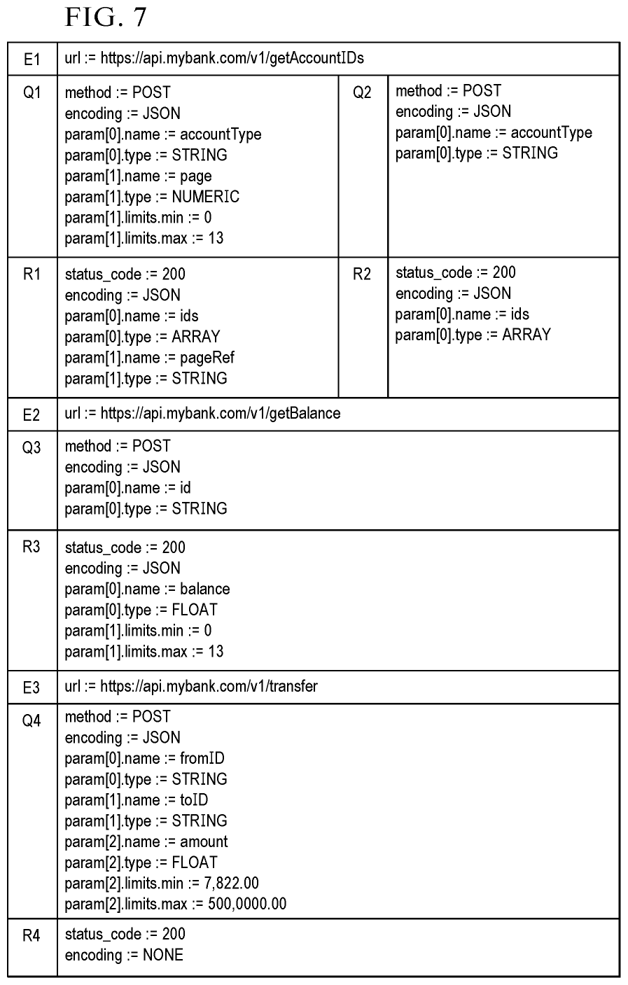

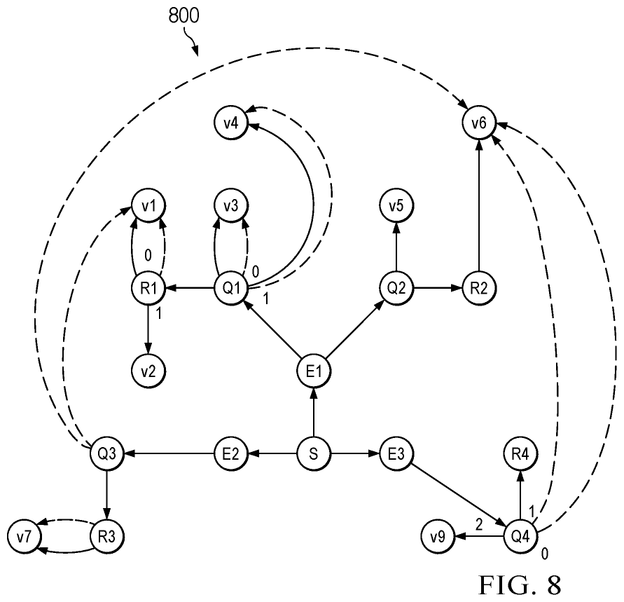

Consider the banking application previously described with respect to FIG. 4. The banking application has several API endpoints. As an example, FIG. 6 depicts a representative behavioral graph 600 generated by the processing technique in FIG. 5. Using the nomenclature outlined above, S is a session vertex, En is an endpoint vertex, Qn is request_signature vertex, Rn is a response_signature vertex, and vn is a value vertex. A solid edge as depicted is evident from its context, e.g., leading to a value vertex is any_value. A dotted edge is a prior_value edge. FIG. 7 depicts representative vertex data for several API endpoints in the behavioral graph 600 shown in FIG. 6. These endpoints include El, corresponding to a getAccountID API, E2, corresponding to a getBalance API, and E3, corresponding to a transfer API. These endpoints are merely representative. FIG. 8 depicts a representative decision graph 800 generated by the API detection mechanism and corresponding to the behavioral graph in FIG. 6. As previously described, the decision graph 800 is a distillation of the behavioral graph 600; preferably, decision graph 800 provides a bare minimum (or some minimal) amount of information requests to determine if a transaction is or is not anomalous. The decision graph 800 has the same structure as the behavioral graph 600 (FIG. 6) from which it is drawn, with the exception that both low frequency behaviors and edge weights are removed.

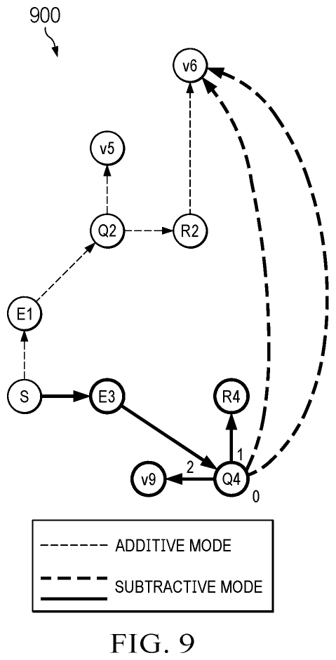

As also previously explained, an override graph may be applied during the generation of the decision graph. As previously noted, preferably an overlay network customer has an option of overriding the decision graph's determination for one or more transactions. This is accomplished through a customer-configured graph that acts as a mask and is overlaid on the decision graph. Continuing with the example scenario, FIG. 9 depicts a representative overrides graph 900 that may be applied for this purpose. The overrides graph also takes the same form as the decision graph with the exception that all vertices and edges (in the override graph) contain an additional attribute, mode, which determines if the element is additive to the decision graph, or subtractive from the decision graph. For illustrative purposes, the example overrides graph 900 shown in FIG. 9 has both additive and subtractive elements, although this is not a requirement. Although in the usual circumstance the override graph 900 is customer-configured, this is not a limitation either, as the system itself may generate an override graph from historical data, from other customer data, or from system or other constraints.

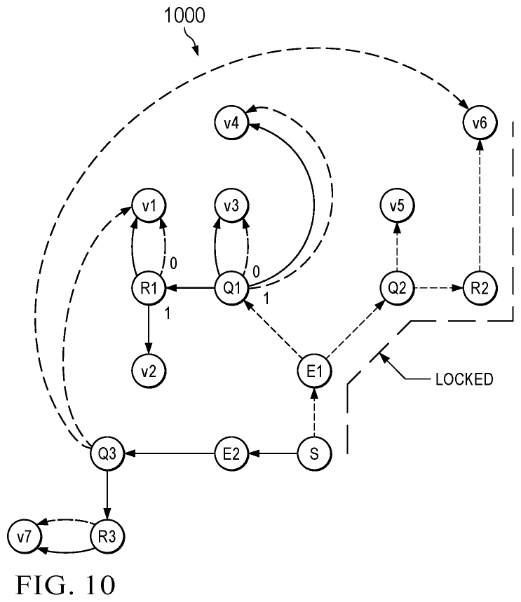

FIG. 10 depicts a modification of the decision graph shown in FIG. 8 after application of the overrides graph shown in FIG. 9. This is then the final decision graph that is instantiated for the application APIs in one or more edge servers (or edge server regions) until it is replaced by a next/updated decision graph for those APIs. As also shown in FIG. 10, a portion of the decision graph may be locked against further change.

There may be one decision graph per application, per API endpoint, per API resource, or otherwise.

The approach herein is highly advantageous as the behavior graph breaks out the actual structure of the API, in other words, the relation between and among the calls, e.g., that call 1 shares an argument with a call 3, that call 4 uses an input that call 2 returned back, and so forth. The graph—which depicts these interdependent relationships—also keeps track of the frequency of these relationships to detect deviations from well-worn patterns. If a path in the graph is low frequency, then it is considered anomalous and pruned during the process of creating the decision graph.

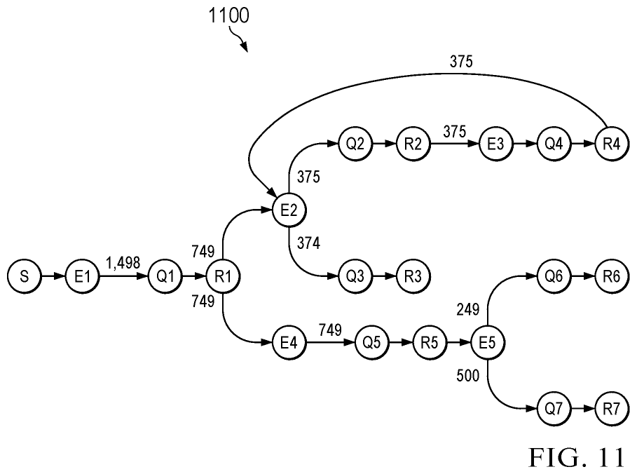

While acyclic graphs are a preferred approach, other graph structures may be used as well. FIG. 11 depicts a representative example. In this variant, the decision graph is further modified to become a directed cyclic graph (DCG) 1100 to capture the transitions from one endpoint to the next. In this embodiment, the endpoint is captured, as well as the request signature and response signature. The edges themselves are weighted to capture the frequency and heat of the occurrence. The motive behind this variation is to include transition from one endpoint to the next to baseline typical observed behavior. For example, whenever an application is used, assume that a typical start yields endpoint E1 being called with a certain set of request parameters. After a response is received, assume that endpoint E2 or E4 is called. E2 is called with either of two (2) sets of input parameters. Continuing with this example, if E2 is called with one request signature it will then later go to E3. If, however, E2 is called with the other type of request signature it terminates. If E2 calls E4, it then calls E5. With this variant, if in a session, if E1 is first invoked and then subsequently E5 is invoked, it would potentially indicate a deviation from the previously gathered typical behavior.

As described above, a behavioral graph may be built locally, e.g., at an edge server through which API transaction flows pass through. In an alternative embodiment, graph building is carried out centrally, as follows. At a high level, API request and response data for specific sessions is sent asynchronously from an edge server HTTP proxy to a processing shard at a processing location. As data can arrive out of order, that processing shard maintains a reordering buffer for incoming transaction information on the order of a handful of seconds. Once a transaction is ready to be promoted from the reordering buffer to the behavioral graph, a session value dictionary, which is centralized on that processing node, is consulted. The session value dictionary is used during the lifetime of a session to determine if a value has been seen previously within a request or a response. Preferably, its keys are hashes (or other suitable stable reductions of the data), while its values are path specification of where the data was first seen. Thus, for example, representative {key, path specification} entries in the dictionary may be as follows:
{1e95dac413ce8879, S→E1→Q1[0]} or
{8429ba034def94f5, S→E1→Q1→R1[0]}.
   The dictionary is used to shore up any difference between any_value edges and shared_value edges before finally committing the set of vertices and edges. After some time interval, the behavioral graph is promoted to a decision graph through the mechanisms described earlier. This decision graph is then distributed back to the edge network. Thus, when transactions arrive at the edge, not only are they sent asynchronously to the central processing shard, but the current installed decision graph is checked to see if the transaction looks anomalous. In this embodiment, the edge server does not have the Session Value Dictionary, and thus there are only some events it will be able to detect, namely, those that express anomalous paths before converging to a value vertex. Back on the central processing node, the next behavioral graph is being constructed, and incoming transactions are also checked for anomalous paths in the last installed decision graph once the value edge has been determined to be an any_value or prior_value. Thus, the central location is able to reflect the full spectrum of attacks.

Representative API attacks that can be detected and mitigated using the techniques herein include, without limitation, OWASP API attacks such as API1:2019 (broken object level authorization), API4:2019 (lack of resources and rate limiting), API5:2019 (broken function level authorization), API6:2019 (mass assignment), API9:2019 (improper assets management), and many others. In a typical operating scenario, and using the above-described heuristic, an anomalous API behavior is detected at the edge network with very low latency.

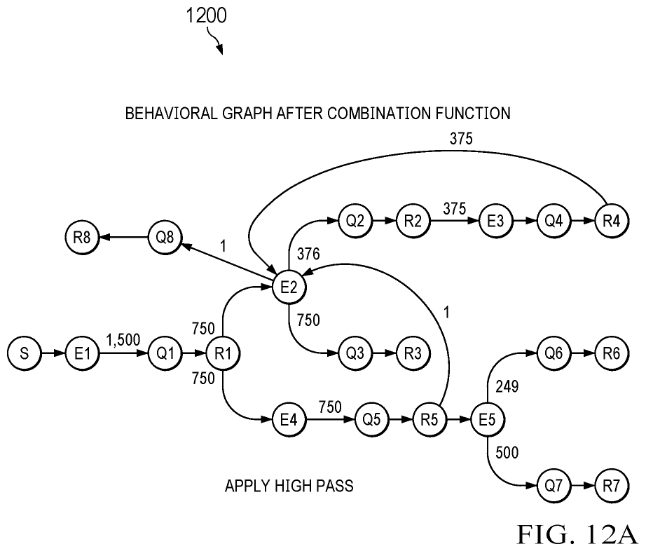

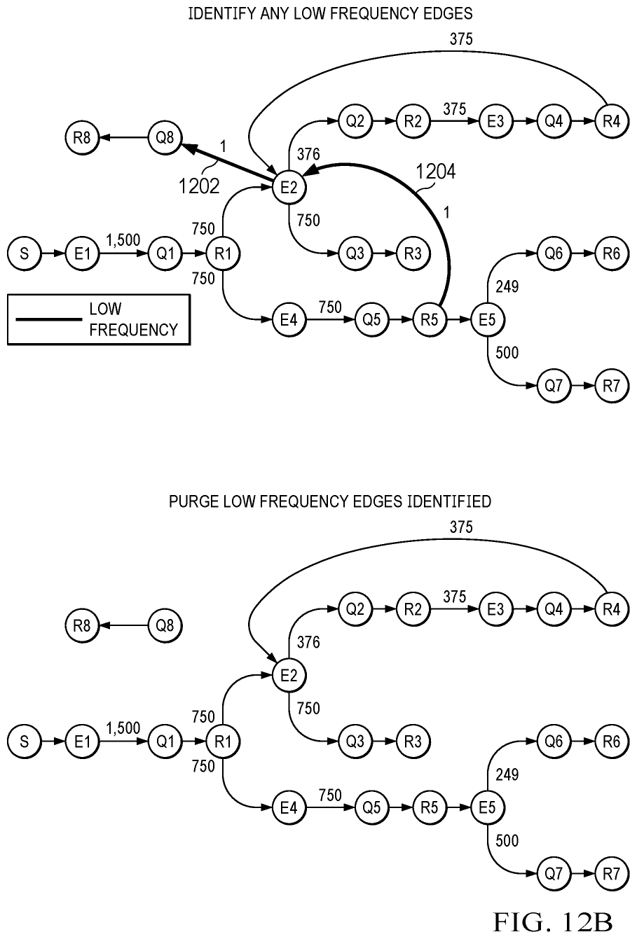

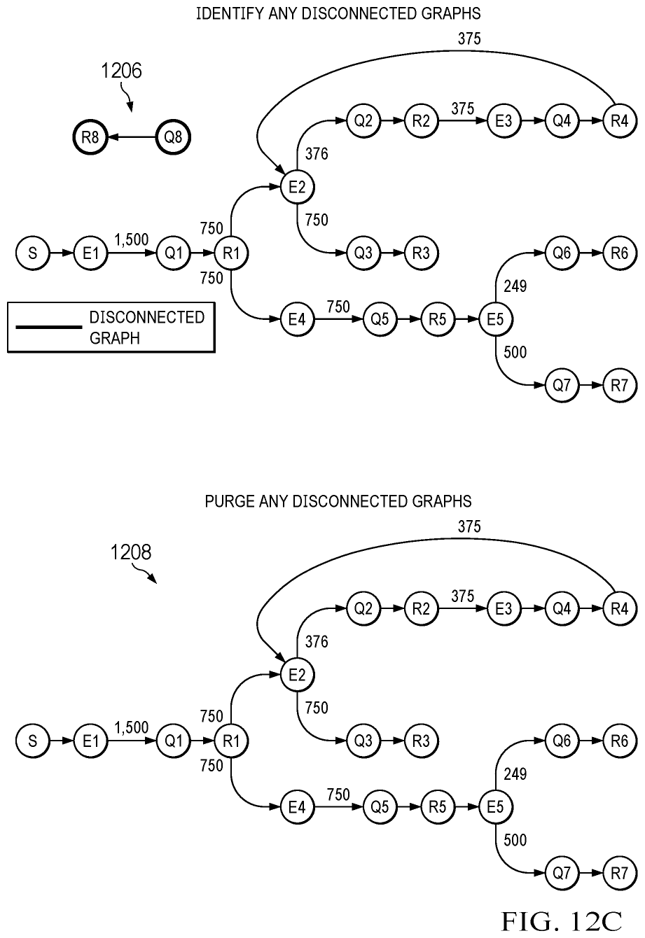

As previously noted, the high pass filtering process prunes low weight edges and orphaned vertices during the process of generating the decision. FIGS. 12A-C depict an example of the high pass filtering operation. In this example, behavioral graph 1200, after a combination operation, is depicted in FIG. 12A. As depicted in the upper portion of FIG. 12B, low weight edges 1202 and 1204 are identified. As depicted in the lower portion of FIG. 12B, these low weight edges are pruned. As depicted in the upper portion of FIG. 12C, two orphaned vertices (the path from Q8 to R8) are also identified. These vertices comprise a disconnected graph 1206. As depicted in the lower portion of FIG. 12C, this disconnected graph is then pruned, leaving the resulting graph 1208. In this example, no override is being applied; thus, the graph 1208 (typically with the weights themselves also removed) is then the decision graph that is then instantiated at an enforcement point.

The technique herein provides significant advantages. It provides for a well-understood, easy-to-reason-about, and suitably efficacious heuristic to detect certain classes of anomalous API behaviors. It provides for a front-end to an API security solution that ensures that only high frequency behaviors—which are assumed to be normal and expected—are enforced with respect to an API endpoint. Low frequency behaviors, on the other hand, are not enforced as they are considered to be anomalous. The technique does not require a priori declarations of an API's behavior (e.g., through means such as Swagger specifications) to achieve its targeted efficiency. The solution is flexible and dynamic, learning new customer behavior while deprecating older behavior, with a configurable adaptation rate.

The approach may be implemented in association with an API acceleration service provided by the overlay network. An API acceleration and security solution that implements the described heuristic meets the unique requirements and challenges of delivering performant API traffic. Indeed, many API responses are dynamic in nature and have smaller payloads than typical HTTP/HTTPS traffic. With API acceleration, customers obtain improvement in both availability and response times for small objects. The approach is highly beneficial for applications with many diverse types of use cases, for example: highly distributed users, for example a public API; dynamic, non-cacheable content that has a high volume of requests; asymmetric traffic flow, for example telemetry or beacons that often have more ingress than egress; bidirectional communication between the app and origin, such as chat, gaming, or social media; B2B data feed, in some instances server to server, where demand originates from a concentrated location; and flash crowds causing rapid spikes in requests, for example gate drop events, betting applications, and online auctions. The API acceleration and security solution may utilize existing edge deployments, a specialized network of servers that can handle the unique profile of dynamic microservices, or a combination of such approaches, to enable reliable API performance at scale. The security solution that is enabled by the graph-based techniques herein secure APIs from a wide range of threats, and amid cloud journeys, modern DevOps practices, and constantly changing applications. The approach herein may also be implemented as parts of a holistic web application and API protection (WAAP) solution that strengthens information security generally and provides insight into emerging risks to target security gaps and stop web and API-based attacks.

The approach herein may also leverage other threat intelligence across the overlay network platform, and it may further self-tuning capabilities designed to reduce operational friction and administrative overhead. In a further variant, all security triggers, including both true attacks and false positives, are automatically analyzed with advanced machine learning (ML) for policy-specific tuning recommendations that can be easily reported and accepted for implementation. A system of this type may also provide support for automated discovery of a full range of known, unknown, and changing APIs across a site's web traffic, including their endpoints, definitions, and traffic profiles. Visibility into APIs helps protect against hidden attacks, find errors, and reveal unexpected changes. In this type of implementation, the manager application is used to easily register newly discovered APIs with just a few clicks. Using the approach herein, preferably all API requests are automatically inspected for malicious code, providing strong API security by default. With the advanced security management option, registered APIs can benefit from additional forms of protections, like the enforcement of API specifications at the edge.

### Enabling Technologies

The techniques herein may be implemented in a computing platform. One or more functions of the computing platform may be implemented conveniently in a cloud-based architecture. As is well-known, cloud computing is a model of service delivery for enabling on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. Available services models that may be leveraged in whole or in part include: Software as a Service (SaaS) (the provider's applications running on cloud infrastructure); Platform as a service (PaaS) (the customer deploys applications that may be created using provider tools onto the cloud infrastructure); Infrastructure as a Service (IaaS) (customer provisions its own processing, storage, networks and other computing resources and can deploy and run operating systems and applications).

The platform may comprise co-located hardware and software resources, or resources that are physically, logically, virtually and/or geographically distinct. Communication networks used to communicate to and from the platform services may be packet-based, non-packet based, and secure or non-secure, or some combination thereof. More generally, the techniques described herein are provided using a set of one or more computing-related entities (systems, machines, processes, programs, libraries, functions, or the like) that together facilitate or provide the described functionality described above. In a typical implementation, a representative machine on which the software executes comprises commodity hardware, an operating system, an application runtime environment, and a set of applications or processes and associated data, that provide the functionality of a given system or subsystem. As described, the functionality may be implemented in a standalone machine, or across a distributed set of machines.

Each above-described process, module or sub-module preferably is implemented in computer software as a set of program instructions executable in one or more processors, as a special-purpose machine.

Representative machines on which the subject matter herein is provided may be Intel Pentium-based computers running a Linux or Linux-variant operating system and one or more applications to carry out the described functionality. One or more of the processes described above are implemented as computer programs, namely, as a set of computer instructions, for performing the functionality described.

While the above describes a particular order of operations performed by certain embodiments of the disclosed subject matter, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the disclosed subject matter has been described in the context of a method or process, the subject matter also relates to apparatus for performing the operations herein. This apparatus may be a particular machine that is specially constructed for the required purposes, or it may comprise a computer otherwise selectively activated or reconfigured by a computer program stored in the computer. Such a computer program may be stored in a computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus. A given implementation of the computing platform is software that executes on a hardware platform running an operating system such as Linux. A machine implementing the techniques herein comprises a hardware processor, and non-transitory computer memory holding computer program instructions that are executed by the processor to perform the above-described methods.

There is no limitation on the type of computing entity that may implement the client-side or server-side of the connection. Any computing entity (system, machine, device, program, process, utility, or the like) may act as the client or the server. While given components of the system have been described separately, one of ordinary skill will appreciate that some of the functions may be combined or shared in given instructions, program sequences, code portions, and the like. Any application or functionality described herein may be implemented as native code, by providing hooks into another application, by facilitating use of the mechanism as a plug-in, by linking to the mechanism, and the like.

The platform functionality may be co-located or various parts/components may be separately and run as distinct functions, perhaps in one or more locations (over a distributed network).

The technique herein is not limited to use in association with an overlay network, or with respect to an edge server operating in such a network. The approach may also be implemented in a standalone manner with respect to an origin server supporting the application and its associated APIs.

What we claim is as follows:

1. A method to detect and mitigate anomalous Application Programming Interface (API) behavior associated with an application having a set of APIs, comprising:
during a given time period, and in response to receiving a set of one or more transactions directed to the application, generating a behavioral graph that comprises a set of vertices, an associated set of edges, and a set of weights representing frequency of observation of one or more behaviors, wherein a behavior is denoted by an edge between a pair of connected vertices, wherein the edge depicts at least one interdependent relationship between first and second APIs of the set of APIs, the first API representing a given transaction, and the second API representing a subsequent transaction associated with the given transaction;
filtering one or more low weight edges from the behavioral graph to generate a decision graph;
using the decision graph to detect whether one or more new transactions represent anomalous behavior; and
responsive to detecting that a given new transaction represents the anomalous behavior, taking an action to protect the application.

2. The method as described in claim 1 wherein each of the first and second APIs is defined by one or more vertices in the set of vertices.

3. The method as described in claim 1 wherein the set of one or more transactions are received across one or more sessions.

4. The method as described in claim 1 further including combining the behavioral graph with a previously-generated behavioral graph prior to filtering the one or more low edge weights.

5. The method as described in claim 4 wherein filtering also remove zero or more orphaned vertices from the behavioral graph.

6. The method as described in claim 1 wherein, in addition to the filtering, an override graph is applied to the behavioral graph to further identify one of more elements of the behavioral graph that are then adjusted to generate the decision graph.

7. The method as described in claim 6 wherein the override graph is configurable.

8. The method as described in claim 1 wherein the method is implemented in association with an overlay network edge server deployment, wherein request and response flows associated with the set of APIs traverse an edge server of the overlay network edge server deployment.

9. The method as described in claim 1 wherein the set of vertices represent components of API requests and responses, and wherein a vertex has an associated type that is one of: session, endpoint, request signature, response signature, and value.

10. The method as described in claim 9 wherein an edge has an associated type that is one of: called, with, returned, any value, and prior value.

11. A computer program product in a non-transitory computer readable medium comprising computer program instructions executable by a hardware processor and configured to detect and mitigate anomalous Application Programming Interface (API) behavior associated with an application having a set of APIs, the computer program instructions comprising program code configured to:
during a given time period, and in response to receiving a set of one or more transactions directed to the application, generate a behavioral graph that comprises a set of vertices, and an associated set of edges, and a set of weights representing frequency of observation of one or more behaviors, wherein a behavior is denoted by an edge between a pair of connected vertices, wherein the edge depicts at least one interdependent relationship between first and second APIs of the set of APIs, the first API representing a given transaction, and the second API representing a subsequent transaction associated with the given transaction;
filter one or more low weight edges from the behavioral graph to generate a decision graph;
use the decision graph to detect whether one or more new transactions represent anomalous behavior; and
responsive to detecting that a given new transaction represents the anomalous behavior, take an action to protect the application.

12. The computer program product as described in claim 11 wherein each of the first and second APIs is defined by one or more vertices in the set of vertices.

13. The computer program product as described in claim 11 wherein the set of one or more transactions are received across one or more sessions.

14. The computer program product as described in claim 11 further including program code configured to combine the behavioral graph with a previously-generated behavioral graph prior to filtering the one or more low edge weights.

15. The computer program product as described in claim 14 wherein the program code configured to filter includes program code configured to remove zero or more orphaned vertices from the behavioral graph.

16. The computer program product as described in claim 11 further including program code configured to apply an override graph to the behavioral graph to further identify one or more elements of the behavioral graph that are adjusted to generate the decision graph.

17. An apparatus, comprising:
a hardware processor; and
computer memory holding computer program code executed by the hardware processor and configured to detect and mitigate anomalous Application Programming Interface (API) behavior associated with an application having a set of APIs, the computer program code configured to:
during a given time period, and in response to receiving a set of one or more transactions directed to the application, generate a behavioral graph that comprises a set of vertices, an associated set of edges, and a set of weights representing frequency of observation of one or more behaviors, wherein a behavior is denoted by an edge between a pair of connected vertices, wherein the edge depicts at least one interdependent relationship between first and second APIs of the set of APIs, the first API representing a given transaction, and the second API representing a subsequent transaction associated with the given transaction;
filter one or more low weight edges from the behavioral graph to generate a decision graph;
use the decision graph to detect whether one or more new transactions represent anomalous behavior; and
responsive to detecting that a given new transaction represents the anomalous behavior, take an action to protect the application.

18. A method of distinguishing behaviors associated with an application having a set of Application Programming Interfaces (APIs), comprising:
in response to receiving a set of transactions directed to the application, generating a behavioral graph that comprises a set of vertices, an associated set of edges, and a set of weights representing frequency of observation of one or more behaviors, wherein a behavior is denoted by an edge between a pair of connected vertices, wherein the edge depicts at least one interdependent relationship between first and second APIs of the set of APIs, the first API representing a given transaction, and the second API representing a subsequent transaction associated with the given transaction;
generating a decision graph by:
combining the behavioral graph with a previously-generated behavioral graph to produce a current behavioral graph;
filtering one or more low weight edge from the current behavioral graph to produce a filtered current behavioral graph; and
applying an override graph to the filtered current behavioral graph; and
instantiating the decision graph to detect whether one or more new transactions represent anomalous behavior.

19. The method as described in claim 18, wherein the decision graph is generated continuously.

20. The method as described in claim 18, wherein the decision graph is instantiated in an overlay network edge server deployment.

21. The method as described in claim 20 wherein request and response flows associated with the set of APIs traverse an edge server of the overlay network edge server deployment.

22. The method as described in claim 18 wherein the previously-generated behavioral graph is generated at a second edge server of the overlay network edge server deployment.

23. The method as described in claim 18 wherein generating the decision graph further includes pruning extraneous information from the current behavioral graph.

24. The method as described in claim 23 wherein the extraneous information are edge weights.

25. The method as described in claim 18 wherein the decision graph is an acyclic directed graph.

26. The method as described in claim 18 wherein the behavioral graph is combined with the prior behavioral graph using an exponential moving average function.
